(19) United States
(12) Patent Application Publication
(10) Pub. No.: US 2007/0087112 A1
(43) Pub. Date: Apr. 19, 2007

(54) Food impurity identifier

(76) Inventors: Malcolm B. Wittenberg, Tiburon, CA (US); Daniel G. Nelson, Los Altos, CA (US)

Correspondence Address: Malcolm B. Wittenberg, 160 Mitchell Boulevard, San Rafael, CA, 94903, US

(21) Appl. No.: 11/248,677

(22) Filed: Oct. 13, 2005

(51) Int. Cl. A23L 3/015

(52) U.S. Cl. 426/665

(57) ABSTRACT

A method of providing a consumer of a food product with data regarding food impurities found therein. The method includes providing an analyzer for the food product while providing food impurity concentration data of the food product. The food product is labeled with the identifier which is associated with the food product at distribution. A website is established for receiving the food impurity concentration data and for displaying the food impurity concentration data in association with the identifier. A consumer is provided the opportunity to learn the food impurity concentration data of the food product bearing the identifier by comparing the identifier on the food product with that recited on the website.

### TECHNICAL FIELD

The present invention deals with a method of providing a consumer of food products with data regarding impurities found therein. By comparing an identifier on the food product with a corresponding identifier on a website or other media outlet, the food impurity concentrations for specific products can be readily communicated to assist consumers in making appropriate decisions regarding the amount and frequency of consumption of such products.

### BACKGROUND OF THE INVENTION

As world populations increase and countries continue to industrialize, pollutants are routinely being introduced into various food chains. In addition, in an attempt to increase food production, many naturally occurring food products have been made the subject of human manipulation in order to enhance product output.

There are many instances in which human manipulation has resulted in food products compromised in terms of their effects upon the human anatomy. For example, most salmon sold at retail emanates from farmed rather than wild sources. Farm salmon is fed food pellets which contain growth hormones, color factors and other constituents to shorten the salmon growth cycle and provide what appears to be a consumer-appealable product. However, tests have shown that farmed salmon contains elevated levels of PCB's, a known carcinogen. Similarly, beef products contain growth hormones and enhancers which, again, can have adverse effects upon the human physiology.

Heavy metals such as lead, mercury and cadmium found in drinking water supplies and food products can have very negative effects as well. For example, mercury is contained at various levels within fish. Although mercury is a natural occurring element, increased amounts of mercury have been introduced into oceans, lakes and streams principally through the burning of mercury-containing coals used in power generation. Mercury-containing off gases enter the atmosphere and are swept by prevailing winds only to be deposited on environmental surfaces and washed into various waterways by periodically occurring rains. Mercury is picked up in aquatic plant life and ingested by small fish which are in turn ingested by larger fish, eventually accumulating within virtually every species of fish to one degree or another. Mercury appears in seafood in its various elemental forms including methylmercury, a deadly poison.

The Food & Drug Administration as well as the U.S. Environmental Protection Agency have studied the mercury contamination issue and have determined that mercury can have a significant and prolonged effect upon the health of those who consume seafood. It has been estimated that there are about 630,000 babies born each year with elevated mercury levels and that about 10% of women of child bearing age in the United States have, in their bloodstreams, mercury levels which are well above normal. This is significant for elevated levels of mercury in women can result in elevated levels in their offspring resulting in neurological problems including lowered I.Q.s as compared to children born without elevated mercury levels. In addition, children as well as young adults have experienced neurological symptoms including memory loss and loss of dexterity when eating seafood, such as albacore tuna, known to be high in mercury, on a regular basis.

Governmental agencies, such as the FDA and EPA have taken a somewhat pragmatic approach noting that in today's industrial society, it is impossible to completely eliminate contaminants from food products. As such, these government agencies have often times suggested limiting the intake of certain food products to enable consumers to reduce risks of contamination by suggesting the ingestion of impurity-containing foods at levels which enable a consumer to such dissipate impurities as they are ingested, thus not increasing the impurity burden on the consumer's physiology.

As a prime example, the FDA has mandated a one part per million (ppm) concentration limit for mercury in seafood sold in the United States. Other countries have established different limits. For example, Canada has mandated a 0.5 ppm mercury limit for seafood sold in that country. The EPA, on the other hand, has established a guide for the accepted consumption of mercury predicated upon variables such as the species of seafood being consumed, the body weight of the consumer and the size of the portions being consumed. The EPA suggests that one consume no more than 0.1 μg of mercury per kg of body weight per day.

Although the EPA guidelines are helpful in theory, practical implementation is not without limitations. One of the principal limitations in executing government guidelines is that consumers are not aware of the precise amount of mercury in any particular seafood species. Certainly, those familiar with this topic know the average concentration of mercury in a particular species of seafood. For example, the following averages have been reported in the media:

| Fish | Average Mercury Concentration (ppm) |
|---|---|
| Tuna (chunk light) | .12 |
| Tuna (Albacore) | .35 |
| Pollack | 0.06 |
| Shrimp | 0.05 |
| Cod | 0.11 |
| Swordfish | 0.97 |
| Salmon | 0.01 |
| Catfish | 0.05 |
| American Lobster | 0.31 |

However, these averages are not indicative of the concentration of mercury in any particular seafood sample being consumed. It is not uncommon for a particular seafood sample to have a mercury concentration which is far removed from the recited average for that species. As such, when a consumer wishing to abide by the EPA guidelines attempts to calculate the amount of mercury in any particular seafood meal, that consumer could be making an assumption regarding mercury concentration values which bear no relationship to the actual seafood being consumed. As such, without additional information, it is impossible for a consumer to follow governmental guidelines and, to this point in time, there has not been a viable means of providing such information.

It is thus an object of the present invention to provide data to a consumer enabling the consumer to somewhat accurately determine the impurity levels of food products being consumed to enable the consumer to make an informed decision about whether such food products should be consumed and, in what amounts.

These and further objects will be more readily appreciated when considering the following disclosure and appended claims.

### SUMMARY OF THE INVENTION

The present invention involves a method of providing a consumer of a food product with data regarding a food impurity found therein. The method comprises providing an analyzer for said food product for providing food impurity concentration data of said food product. The food product is labeled with an identifier, the identifier to be associated with the food product at distribution. A website is established for receiving the food impurity concentration data and for displaying the food impurity concentration data in association with the identifier such that a consumer is provided the opportunity to learn the food impurity concentration data of the food product bearing the identifier.

### BRIEF DESCRIPTION OF THE FIGURES

The present invention is illustrated by way of example and not limitation in the figures of the accompanying drawings, in which like references indicate similar elements, and in which:

FIG. 1 illustrates a network environment that can be used to implement embodiments of the present invention; and

FIG. 2 is a flow chart that illustrates the steps of associating a food impurity with a food product according to a method of the present invention.

### DETAILED DESCRIPTION OF THE INVENTION

A description of the invention which follows is, by example, directed to mercury as an impurity found in seafood. However, it will be quite evident to one of ordinary skill in the art that the present method could be applied to other impurities found in other food products. In fact, food products for implementation of the present invention could be any of those representing a member selected from the group consisting of seafood, meat, poultry, water and grain. The impurities can comprise members selected from the group consisting of heavy metals, pesticides, bacteria, histamines and organics.

Aspects of the present invention could be used as a distributed electronic commerce application that includes a computer network system that links one or more server computers to one or more client computers. The client and server computers may be desk top personal computers, work station computers, mobile computers, portable computing devices, personal digital assistant (PDA) devices, or any other similar type of computing device. The steps of accessing, downloading and manipulating data as well as other aspects of the present invention are implemented by central processing units (CPU) in the server and client computers executing sequences of instructions stored in a memory. The memory may be a random access (RAM), read-only memory (ROM), a persistent store, such as a mass storage device, or any combination of these devices. Execution of the sequence of instructions causes the CPU to perform steps according to embodiments of the present invention.

In turning once again to the mercury impurity example as it pertains to seafood, it is contemplated that seafood either at a processing facility where fishing boats are unloaded or at wholesale facilities where seafood is accepted, manipulated and distributed to other wholesale and retail customers, would be tested for its mercury concentration. Any suitable test device can be employed including those available from AGS Scientific, Lumex, Genesis Laboratory Systems and PerkinElmer.

As seafood is tested, it would be identified in a suitable fashion wherein the identifier, such as a serial number would remain with the seafood product as it passes from processor to wholesale and wholesaler to consumer or retail sales outlet.

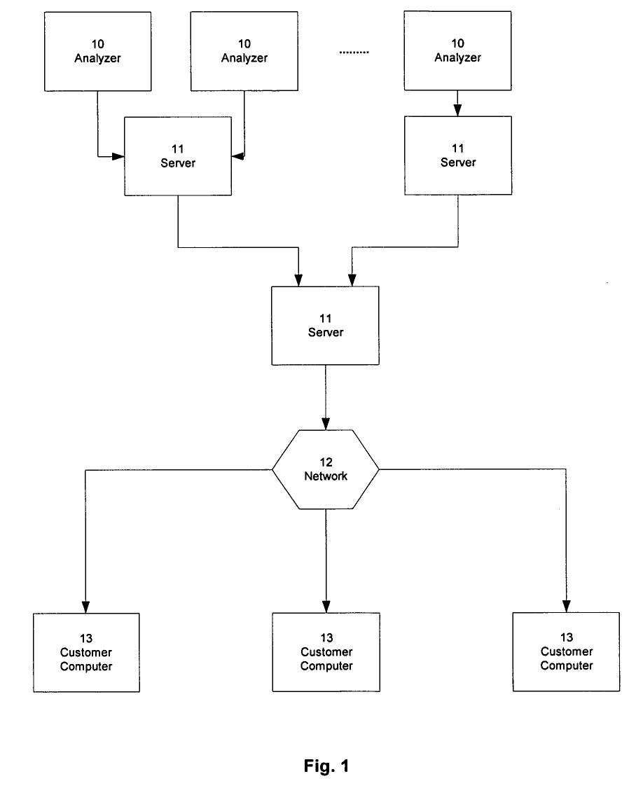

Turning to FIG. 1, analyzer 10 can again be installed at a suitable facility such as a seafood processor or a wholesale distributor where individual pieces of seafood or lots of seafood are tested using commercially available analytical techniques. FIG. 1 shows two analyzers 10 illustrating the notion that analyzers are contemplated to be installed at multiple facilities and multiple analyzers in a single facility while remaining within the spirit and scope of the present invention. As an illustration for implementing the present method, individual fish or lots of fish once tested for their mercury concentration using analyzer 10, would be associated with a serial number. The serial number would be used to identify the fish species being tested and its mercury concentration. Such information would be provided to server computers 11 coupled to customer computer 13 via network 12. The network 12 may be a simple peer-to-peer connection, a private network (e.g., LAN), a wide area network (WAN), or the Internet. In one embodiment the server computers 11 is several computers connected via network with one computer aggregating the information from other computers for central distribution to the network 12. For the embodiment in which network 12 comprises the Internet, the server computers 11 and customer computer 13 would communicate using an Internet protocol. In the world wide web environment, the network customer computer 13 typically accesses the Internet network 12 through an Internet Service Provider (ISP) and executes a web browser program to display data content through web pages. In one embodiment, the web browser program is implemented using Microsoft® Internet Explorer™ browser software, but other web browser programs may also be used. For the web-based implementation, server computer 11 executes a web server process that serves web content from a website maintained on server computer 11. In another embodiment, customer computer 13 may run a proprietary program for retrieving and displaying the food product information transmitted over the network 12 from the server computers 11.

In implementation, it is contemplated that a customer in possession of customer computer 13 would purchase seafood made the subject of testing through analyzer 10. The seafood purchased by the customer would bear an identifier tag such as a serial number generated by analyzer 10 and provided to server computer 11. The customer, in accessing network 12 through use of customer computer 13, would access an appropriate website and enter, in the appropriate field, the serial number as it is recited on the identifier or label appended to the seafood product at time of purchase. Data regarding the seafood product as to its species and measured mercury concentration associated with the identifier would then be made available to the customer through customer computer 13 accessing network 12. Customers would thus be made aware of precise mercury concentrations in the seafood they had purchased as such data is generated by analyzer 10.

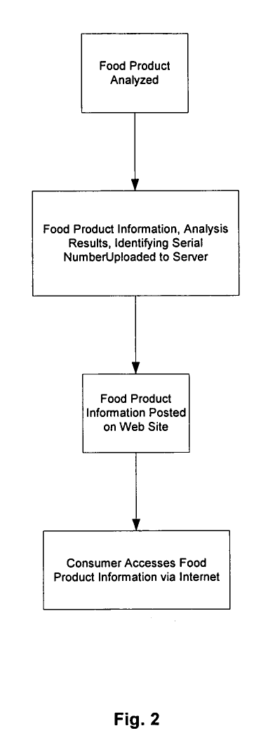

FIG. 2 is a flow chart that illustrates the method described above. In step 20, a food product, such as fish, is analyzed for an impurity such as its mercury concentration. As an alternative, the seafood could be tested for, for example, cadmium, histamine or PCB concentrations as well. Results generated at step 20 are provided to a computer server indicating the characterization of the product, such as the species and assigned serial number further including the contaminant concentration thereof. This information is provided from the computer server to a suitable network and posted on a website maintained by or in conjunction with the analyzing entity as shown as step 22 of FIG. 2. Finally, in flow chart step 23, a consumer would access the website entering the subject serial number for concentration lookup.

In taking advantage of the above-recited method, guidelines such as those proposed by the EPA now make emanate sense. Instead of guessing as to the mercury concentration of seafood contemplated for consumption, by taking advantage of the present method, the precise mercury concentration determined by analyzer 10 at a remote facility is provided the consumer. By entering the quantity of seafood being consumed, such as 6, 8 or 10 ounces, for example, and the body weight of the consumer, one can ensure by taking advantage of the EPA guidelines recited above that one does not exceed recommended mercury consumption levels in planning an appropriate diet.

Again, although emphasis was placed upon the mercury contamination issue as it applies to seafood, the present invention can be implemented as to virtually any food impurity in providing a consumer with impurity concentration data to improve the consumer's general physiology and overall health.

1. A method of providing a consumer of a food product with data regarding a food impurity found therein, said method comprising providing an analyzer for said food product for determining food impurity concentration data of said food product, labeling said food product with an identifier, said identifier being associated with said food product and the concentration of said impurity generated by said analyzer, said identifier being further associated with said food product at distribution, establishing a website for receiving said food impurity concentration data and for displaying said food impurity concentration data in association with said identifier such that a consumer is provided the opportunity to learn the food impurity concentration data of said food product bearing said identifier by accessing said website.

2. The method of claim 1 wherein said food product is a member selected from the group consisting of seafood, meat, poultry, water, and grain.

3. The method of claim 2 wherein said impurity comprises a member selected from the group consisting of heavy metals, pesticides, bacteria, histamines and organics.

4. The method of claim 3 wherein said food product comprises seafood and said impurity comprises mercury.

5. The method of claim 1 wherein said identifier comprises a serial number.

6. The method of claim 5 wherein said serial number is displayed on said website and on said identifier enabling said consumer to match said serial number on said food product with said serial number on said website.

7. The method of claim 1 wherein said website further communicates recommended safety levels of said impurities based upon established recommendations.

8. The method of claim 7 wherein said established recommendations are those established by at least one governmental agency.

9. The method of claim 8 wherein said at least one governmental agency is the U.S. Food & Drug Administration.

10. The method of claim 8 wherein said at least one governmental agency is the U.S. Environmental Protection Agency.

11. The method of claim 7 wherein said food product is seafood and said impurity is mercury and said recommended safety levels are not to exceed 0.1 μg of mercury per kilogram of body weight per day.

12. A method of providing a consumer of seafood with mercury level data corresponding to said seafood, said method comprising providing an analyzer for measuring mercury concentration data of said seafood, labeling said seafood with an identifier, said identifier to be associated with said measured mercury concentration and species of seafood at distribution, establishing a website for receiving said mercury concentration data and for displaying said mercury concentration data in association with said identifier such that a consumer is provided the opportunity to learn the mercury concentration data of seafood bearing said identifier on said website.

13. The method of claim 12 wherein said identifier comprises a serial number.

14. The method of claim 13 wherein said serial number is displayed on said website and on said identifier enabling said consumer to match said serial number on said seafood with said serial number on said website.

15. The method of claim 12 wherein said website further communicates recommended safety levels of said mercury based upon established recommendations.

16. The method of claim 15 wherein said established recommendations of those established by at least one governmental agency.

17. The method of claim 16 wherein said at least one governmental agency is the U.S. Food & Drug Administration.

18. The method of claim 16 wherein said at least one governmental agency is the U.S. Environmental Protection Agency.

19. The method of claim 15 wherein said recommendation safety levels are not to exceed 0.1 μg Hg per kilogram of body weight per day.
